(19) United States
(12) Patent Application Publication
(10) Pub. No.: US 2012/0103171 A1
(43) Pub. Date: May 3, 2012

(54) Bridge for a Stringed Musical Instrument

(76) Inventor: Larry David Lashbrook, Fort Lauderdale, FL (US)

(21) Appl. No.: 13/126,211

(22) PCT Filed: Oct. 28, 2009
(86) PCT No.: PCT/US09/62444

§ 371 Date: Sep. 7, 2011

Related U.S. Application Data
(60) Provisional application No. 61/109,002, filed on Oct. 28, 2008.

(51) Int. Cl. G10D 3/04; G10H 3/18

(52) U.S. Cl. 84/731; 84/307

(57) ABSTRACT

The present invention provides a bridge for a stringed instrument with improved structure design which allows the bridge to be made of light-weight acoustically resonant material. The bridge comprises a plurality of adjustable saddles that are always in contact with the adjacent saddles, the internal bottom wall, and/or the end walls of the first chamber of the bridge. The constant contacts enable these plurality of parts to be unified by pressure allowing for excellent transmission of the string vibrations. The compressive load provided by these constant contacts enables the instant bridge to withstand even the heaviest load of strings. In addition, the bridge comprises thin walls facilitating resonance. The bridge may also comprise internal piezoelectric elements. The bridge is able to produce authentic acoustic sounds for an electric guitar without the need for pre-amplification or signal conditioning.

### CROSS REFERENCE TO RELATED APPLICATIONS

This application claims the benefit under 35 U.S.C. §119(e) of U.S. Provisional Application No. 61/109,002, filed on Oct. 28, 2008.

### FIELD OF THE INVENTION

The present invention relates to bridges for stringed musical instruments. In particular, the present invention relates to bridges for guitars.

### BACKGROUND OF THE INVENTION

On a stringed musical instrument, a bridge is a device for supporting the strings and transmitting the vibration of the strings to other structural components of the instrument to maximize intensity of the sound. A pickup can be part of the bridge assembly which acts as a transducer to convert mechanical vibrations of the strings to electrical signals. An amplifier system then receives and amplifies the electric signals for acoustic emission. In general, an electric guitar has a magnetic pickup which converts string vibrations inside a magnetic field to electric currents. An acoustic guitar typically has a piezoelectric transducer which comprises piezoelectric material, such as certain crystals and ceramics, that is able to convert applied mechanic stress to electric currents. (see, Piezoelectricity [on-line]. Retrieved on Oct. 28, 2009 from URL: http://en.wikipedia.org/wiki/Piezoelectricity)

For acoustic simulation and sound versatility, piezoelectric bridges with embedded piezoelectric transducers have also been designed for use on an electric guitar. In addition, the piezoelectric bridge allows the electric guitar to produce sounds at high volume without feedback, a drawback normally associated with acoustic guitars. A typical piezoelectric bridge for an electric guitar comprises tunable saddles, and is made of metal to withstand the string tensions associated with an electric guitar. However, the metal bridge produces a low output signal with improper frequencies and brittle tones. Therefore, sophisticated electronic preamplifiers and equalizers are needed to condition the signals from metal piezoelectric bridges prior to final amplification.

U.S. Pat. No. 5,814,745 refers to a fully adjustable acoustic guitar bridge that allows the strings (e.g. nylon or steel) of an acoustic guitar to be separately and continuously intonated. In one embodiment, recessed rear-loaded cap screws utilize the forward and downward pull of the strings to stabilize the adjustable saddles; in another, recessed, front-loaded cap screws utilize a c-clip to stabilize the saddles. A threaded saddle capture on each saddle provides stability and allows the use of acoustically resonant materials for saddles. In one embodiment, the string's downward pressure transmits string vibration to the soundboard; in another, a set-screw assists this transference of sound. In one embodiment, a rosewood shim is employed on acoustic/electric guitars over the internal bridge pickup. The vibration of the saddles on the shim is transmitted to the pickup regardless whether the saddles are located directly over the pickup or not. U.S. Pat. No. 7,268,291 discloses a bridge consisting a pair of support legs against the sound box under the pressure of the strings, and at least two piezoelectric transducers where each of them is disposed between each support leg and the sound box. The transducers are retained in position only by the pressure of the support leg against the sound box. The bridge or the saddle disclosed is not adjustable. U.S. Pat. No. 5,410,101 describes a piezoelectric assembly in a dual layer arrangement clamped between a bridge and a string holder. The piezoelectric assembly is made up of a first group of aligned piezoelectric elements, a second group of piezoelectric elements which underlies the first group, and electrodes each clamped between a pair of associated piezoelectric elements. The piezoelectric elements closer to the string holder detect string vibrations and the piezoelectric elements closer to the bridge detects body vibrations of the string instrument so that electric signals from piezoelectric elements of different groups can be blended together.

There is still a need to improve the acoustic simulation capability of an electric guitar bridge without the use of the pre-amplifiers or conditioning systems. It is also advantageous to improve the structure design of the bridges for electric guitars so that light-weight materials can be used to allow the bridge to vibrate and resonate better.

### BRIEF DESCRIPTION OF THE DRAWINGS

FIG. 1 shows a top view of a guitar having a neck, a body, a bridge and a plurality of strings.

FIG. 2 shows a top view of one embodiment of the piezoelectric bridge.

FIG. 3 shows a side view of the piezoelectric bridge in FIG. 2.

FIG. 4 shows an end view of the piezoelectric bridge in FIG. 2.

FIG. 5 shows an exploded side view of the piezoelectric bridge in FIG. 2.

FIG. 6 shows an exploded top view of the piezoelectric bridge in FIG. 2.

FIG. 7 shows a top view of the bridge body of the piezoelectric bridge in FIG. 2, illustrating the first chamber.

FIG. 8 shows a bottom view of the bridge body of the piezoelectric bridge in FIG. 2, illustrating the second chamber.

FIG. 9 shows a side view of the bridge body of the piezoelectric bridge in FIG. 2, illustrating the unthreaded holes on the side of the bridge body to hold threaded members that may be used to adjust the positions of the saddles.

FIG. 10 shows a cross section of the piezoelectric bridge body in FIG. 2, sliced along the longitudinal axis of the bridge, illustrating the primary diaphragm between the first chamber and the second chamber, as well as the design of the second chamber.

FIG. 11 shows a cross section of the piezoelectric bridge in FIG. 2, sliced along the transverse axis of the bridge.

FIG. 12 shows a top view of the bridge according to the present invention, illustrating that for a plurality of saddles positioned within the first chamber, adjacent saddles are always in direct contact at any point of travel, and the saddles positioned at either end of the plurality of saddles are always in direct contact with the end walls of the first chamber.

FIG. 13 shows a cross section of the bridge according to the present invention, illustrating that for a plurality of saddles positioned within the first chamber, the bottom side of each saddle is always in contact with the bottom wall of the first chamber.

FIG. 14A shows one embodiment of the saddles, illustrating three different heights for the plurality of saddles.

FIG. 14B shows various embodiments of the saddles.

FIG. 15 shows one embodiment of the piezoelectric elements and the connective wiring.

FIGS. 16-19 show cross sections of various embodiments of an end portion of the second chamber receiving the piezoelectric elements, illustrating the unique designs of the second chamber.

FIG. 20 shows a top view of one embodiment of the bridge where the bridge is assembled with archtop guitar style mounting base.

FIG. 21 shows a side view of the bridge in FIG. 20.

FIG. 22 shows an end view of the bridge in FIG. 20.

FIG. 23 shows a top view of one embodiment of the bridge where the bridge is assembled with flat top guitar style mounting base.

FIG. 24 shows a side view of the bridge in FIG. 23.

FIG. 25 shows an end view of the bridge in FIG. 23.

FIG. 26 shows a top view of one embodiment of the bridge where the bridge is assembled with flat top style mounting base and comprises non-adjustable saddles.

FIG. 27 shows a side view of the bridge in FIG. 26.

FIG. 28 shows an end view of the bridge in FIG. 26.

FIG. 29 shows an exploded side view of one embodiment of the bridge without piezoelectric element.

FIG. 30 shows an exploded top view of the bridge in FIG. 29.

FIG. 31 shows a top view of the bridge in FIG. 29.

FIG. 32 shows a bottom view of the bridge in FIG. 29.

FIG. 33 shows a side view of the bridge in FIG. 29.

FIG. 34 shows one embodiment of the mounting member, washer and nut.

FIG. 35 shows a cross section of the bridge according to the present invention, illustrating the configuration of the mounting member, and the loose fit around the mounting member allowing for adjustment without binding.

FIG. 36 shows one embodiment of the bridge where the primary diaphragm is a separate structure that is further connected to the walls of the first chamber and the walls of the second chamber by suitable means.

FIGS. 37a and 37b show a top view and a side view of the fender telecaster style bridge, respectively.

FIGS. 37c and 37d show a side view and a top view, respectively, of one embodiment of the present bridge that can be incorporated into the fender telecaster style bridge.

FIGS. 37e and 37f show a top view and a side view, respectively, of one embodiment of the present bridge that is incorporated into the fender telecaster style bridge.

### SUMMARY OF THE INVENTION

It is an object of the present invention to provide a bridge for a musical instrument comprising a first chamber, a transverse axis and a longitudinal axis, wherein a plurality of saddles are positioned within the first chamber. Adjacent saddles are in direct contact at any position; at least one side of each saddle is in contact with at least one wall of the first chamber. The saddles that are positioned at either end of the plurality of saddles are in direct contact with the end walls of the first chamber. Each saddle has a hole oriented transversely across the saddle, wherein a threaded member is positioned within the hole, the threaded member being attached to one side of the first chamber. A mounting means is positioned at both ends of the bridge for attaching the bridge to the musical instrument. The mounting means can be a mounting member positioned within a hole oriented vertically in the bridge. The position of the saddle can be adjusted by adjusting the threaded member. The width of the saddle may be greater than half of the internal width of the first chamber. The bridge and the saddles may be made of light-weight acoustically resonant material, including wood, aluminum, fiberglass, carbon fiber, graphite, bone, plastic, ivory, polyborontrinitrate, corian, micarta, phenolic, and combinations thereof.

The bridge may further comprise a second chamber that is positioned below the first chamber and runs lengthwise across the longitudinal axis of the bridge. At least one piezoelectric element may be positioned within the second chamber. The mounting member runs through, but is not in direct contact with, the piezoelectric element. At least one of the piezoelectric elements may be a piezoelectric ring transducer. At least one of the piezoelectric ring transducer may encircle at least one of the mounting means on at least one end of the bridge. The diameter of the piezoelectric ring transducer may range from about 10 mm to about 30 mm, from about 12 mm to about 25 mm, from about 15 mm to about 20 mm. The thickness of the piezoelectric element may range from about 1 mm to about 6 mm, from about 2 mm to about 5 mm, or about 3 mm. At least a portion of the upper surface of the second chamber may be recessed to allow greater vibration of the piezoelectric element. A peripheral diaphragm may be placed between the recessed surface of the second chamber and the piezoelectric element. A primary diaphragm may separate the first chamber and the second chamber. The thickness of the primary diaphragm may range from about 1 mm to about 10 mm, from about 2 mm to about 8 mm, or from about 3 mm to about 6 mm. A secondary diaphragm may be placed in contact with the side of the piezoelectric element that is further from the first chamber. The thickness of the secondary diaphragm may range from about 1 mm to about 5 mm, from about 1.5 mm to about 4 mm, or from about 2 mm to about 3 mm. The surface area where the second chamber is in contact with the piezoelectric element may be less than the area of the piezoelectric element. The mounting means can be used to adjust the height of the bridge.

The constant contacts between adjacent saddles, between saddles and the end walls of the first chamber, and between saddles and the internal bottom wall of the first chamber collectively create a compressive load-bearing structure allowing for the bridge to be made of light-weight acoustically resonant materials, and allowing for the bridge to comprise wall structures including the primary diaphragm and the secondary diaphragm. The compressive load-bearing structure unifies the plurality of parts and maximizes the vibrations transmitted.

It is also an object of the present invention to provide a bridge for a musical instrument comprising a transverse axis and a longitudinal axis, the bridge having at least one hole oriented vertically in the bridge with a mounting member positioned within the hole, wherein the bridge is made of light-weight acoustically resonant material. The bridge may further comprise a first chamber wherein at least one saddle is positioned within the first chamber. The bridge may comprise a second chamber wherein at least one piezoelectric element is positioned within the second chamber. The mounting member can be used to adjust the height of the bridge.

### DETAILED DESCRIPTION OF THE INVENTION

The present invention provides a bridge for a stringed instrument with structure design that allows the bridge to be made of comparatively light-weight, acoustically resonant material. The comparatively light-weight, acoustically resonant material is described more fully below. The bridge contains a plurality of adjustable saddles. The adjacent saddles are always in direct contact. Each saddle is always in contact with the internal bottom wall of the first chamber of the bridge. The saddles that are positioned at either end of the plurality of saddles are always in direct contact with the end walls of the first chamber. The compressive load provided by these constant contacts enables the instant bridge to withstand even the heaviest load of strings. The constant contacts between the saddles, and between the saddles and the walls of the first chamber of the bridge, also enable these plurality of parts to be unified by pressure allowing for excellent transmission of the string vibrations. In addition, the bridge has walls facilitating resonance. The bridge may also comprise piezoelectric elements. The bridge resonates with the instrument with a high degree of fidelity, and is able to produce authentic acoustic sounds for an electric guitar without the need for pre-amplification or signal conditioning.

The bridge of the present invention comprises a first chamber, a transverse axis and a longitudinal axis. A plurality of saddles are positioned within the first chamber. Adjacent saddles are in direct contact at any position. At least one side of each saddle is in contact with at least one wall of the first chamber. The saddles that are positioned at either end of the plurality of saddles are in direct contact with the end walls of the first chamber. Each saddle has a hole oriented transversely across the saddle. A threaded member is positioned within the hole, and is attached to one side of the first chamber. The bridge also has a mounting means at both ends of the bridge for attaching the bridge to the musical instrument. Each saddle of the bridge can be moved toward or away from the neck of the instrument by adjusting the threaded members, while the threaded members are restrained for limited linear movement mechanically by clips or female threaded members. The adjustable saddles allow the vibrating length of each string to be individually adjusted, thus fine-tuning the intonation of each string. The bridge has a mounting means at both ends of the bridge for attaching the bridge to the musical instrument. The mounting means may be a mounting member positioned within a hole that is oriented vertically in the bridge.

The bridge of the present invention may also comprise a second chamber that is positioned below the first chamber and runs lengthwise across the longitudinal axis of the bridge. At least one piezoelectric element may be positioned within the second chamber. The mounting member runs through at least one piezoelectric element. The mounting member may or may not be in direct contact with the piezoelectric element. The first chamber and the second chamber share a wall which may act as a primary diaphragm. The thickness of the primary diaphragm may range from about 1 mm to about 10 mm, from about 2 mm to about 8 mm, or from about 3 mm to about 6 mm. The thickness of the primary diaphragm may be constant across the whole structure, or may be different at various points of the structure. In one embodiment, the surface area where the second chamber is in contact with the piezoelectric element is less than the area of the piezoelectric element so that the piezoelectric element is able to experience great vibration. In a further embodiment of the invention, the bridge does not comprise a second chamber or any piezoelectric element. The thickness of the walls of the bridge constant across the whole structure, or may be different at various points of the structure.

A conventional piezoelectric bridge for an electric guitar is made of metal. Due to its mass and density, metal, such as steel, brass and zinc, partially absorbs and dampens the sound waves transmitted. Therefore, a guitar with a metal bridge body or metal saddles produces a thin, brittle tone with little resonance and richness of the notes played. In contrast, the design of the instant bridge allows the bridge body and the saddles to be made of any comparatively light-weight acoustically resonant material. Acoustically resonant material has the ability to transmit the sound waves faithfully from one point to another with little or no degradation. Therefore, the bridge of the present invention can resonate with the instrument to produce acoustical sounds. Examples of the comparatively light-weight acoustically resonant materials include, but are not limited to, wood, fiberglass, carbon fiber, graphite, aluminum, bone, plastic, ivory, polyborontrinitrate, corian, micarta, phenolic, as well as their combinations. The specific gravity of the wood that may be used to make the present bridge may range from about 0.1 to about 1.5, from about 0.5 to about 1.4, or from about 1 to about 1.35. The bridge or saddles of the present invention may be made of tone woods such as ebony or rosewood. “Specific gravity” herein refers to the ratio of the density of a given substance to the density of water at 4° C. and 1 atm. The present bridge may be made of any comparatively light-weight acoustically resonant material, or may be made of any other suitable material. The bridge of the present invention is lighter in weight than the bridges disclosed in the prior art regardless of the material due to its design. In embodiments where the bridge of the present invention and the bridges in the prior art are made of the same material, such as metal, the instant bridge is lighter and resonates better than the bridges in the prior art; the instant bridge also achieves a higher degree of fidelity, and is able to produce more authentic acoustic sounds for an instrument than the bridges in the prior art. The present bridge may be made of a single material or different materials. The bridge body and the saddles may be made of the same material or different materials.

In one embodiment of the present invention, at least one of the piezoelectric elements of the bridge is a piezoelectric ring transducer. The piezoelectric ring transducer may have a diameter of greater than about 10 mm. The large size of the piezoelectric elements provides for great vibration, and therefore, a strong signal. The diameter of the piezoelectric ring transducer may range from about 10 mm to about 30 mm, from about 12 mm to about 25 mm, from about 15 mm to about 20 mm, or about 13 mm. The piezoelectric element may have a flat shape with a thickness ranging from about 1 mm to about 6 mm, from about 2 mm to about 5 mm, or about 3 mm. The thickness of the piezoelectric element may be constant across the whole structure, or may be different at various points of the structure. The number of piezoelectric elements of the bridge may be one, two, three, four, five, six or any other desired number. The piezoelectric element may be circular, oval, rectangular, trapezoid, square or any other desired shape. The piezoelectric element may be symmetrical or asymmetrical in shape. The piezoelectric element may have a flat, elongated shape. The piezoelectric element may have a coaxial structure with a central conductor, a piezoelectric polymer layer and an outer conductor. The piezoelectric element may take the form of a film tape that is helically wrapped or woven about a central conductor core as disclosed in U.S. Pat. No. 6,677,514. The area where the second chamber is in contact with the piezoelectric element may be less than, larger than, or the same as, the area of the piezoelectric element. In one embodiment, at least one of the piezoelectric ring transducer encircles at least one of the mounting member on at least one end of the bridge. In a preferred embodiment, only the center of the piezoelectric element is supported, allowing its outer area to remain free to vibrate so as to maximize the signal strength.

Part of the upper surface of the second chamber may be recessed to allow free vibration of the piezoelectric element. Top, up, upper etc. herein refer to points of the bridge that are closer to the strings and further from the instrument body. Down, lower, bottom etc. herein refer to points of the bridge that are toward or closer to the instrument body. Transverse herein refers to directions at right angles to the longitudinal axis of the bridge. A peripheral diaphragm made of resonant material may be placed between the recessed surface of the second chamber and the piezoelectric element. The peripheral diaphragm may be approximately the size of the piezoelectric element, or may be larger or smaller than the size of the piezoelectric element. The peripheral diaphragm transmits string vibrations from the saddles to the piezoelectric element. A resonant secondary diaphragm may be placed in contact with the bottom side of the piezoelectric element. The secondary diaphragm may also act as a bottom cover for the second chamber.

The first chamber or the second chamber may be positioned in the center of the bridge, or may be positioned closer to one side or one end of the bridge in comparison to the other side or end of the bridge.

The height of the bridge can be adjusted by adjusting the mounting means on either end of the bridge. In one embodiment, the mounting means is a mounting member including a socket head allen bolt recessed into the top of the bridge and a nut. The nut is secured to the bolt by adhesive, pin, or any other suitable means.

The width of the bridge may range from about 5 mm to about 30 mm, from about 8 mm to about 25 mm, or from about 10 mm to about 20 mm. The length of the bridge may range from about 30 mm to about 200 mm, from about 40 mm to about 150 mm, or from about 50 mm to about 120 mm. The height of the bridge may range from about 2 mm to about 30 mm, from about 5 mm to about 25 mm, or from about 8 mm to about 20 mm. The width of the first chamber may range from about 2 mm to about 25 mm, from about 4 mm to about 20 mm, or from about 6 mm to about 15 mm. The length of the first chamber may range from about 20 mm to about 180 mm, from about 30 mm to about 120 mm, or from about 40 mm to about 100 mm. The depth of the first chamber may range from about 1 mm to about 20 mm, from about 3 mm to about 15 mm, or from about 4 mm to about 10 mm. The width of the saddle may range from about 1.5 mm to about 20 mm, from about 2 mm to about 15 mm, or from about 3 mm to about 10 mm. The length of the saddle may range from about 3 mm to about 40 mm, from about 4 mm to about 30 mm, or from about 5 mm to about 20 mm. The height of the saddle may range from about 1 mm to about 30 mm, from about 3 mm to about 25 mm, from about 5 mm to about 20 mm, or from about 6 mm to about 15 mm.

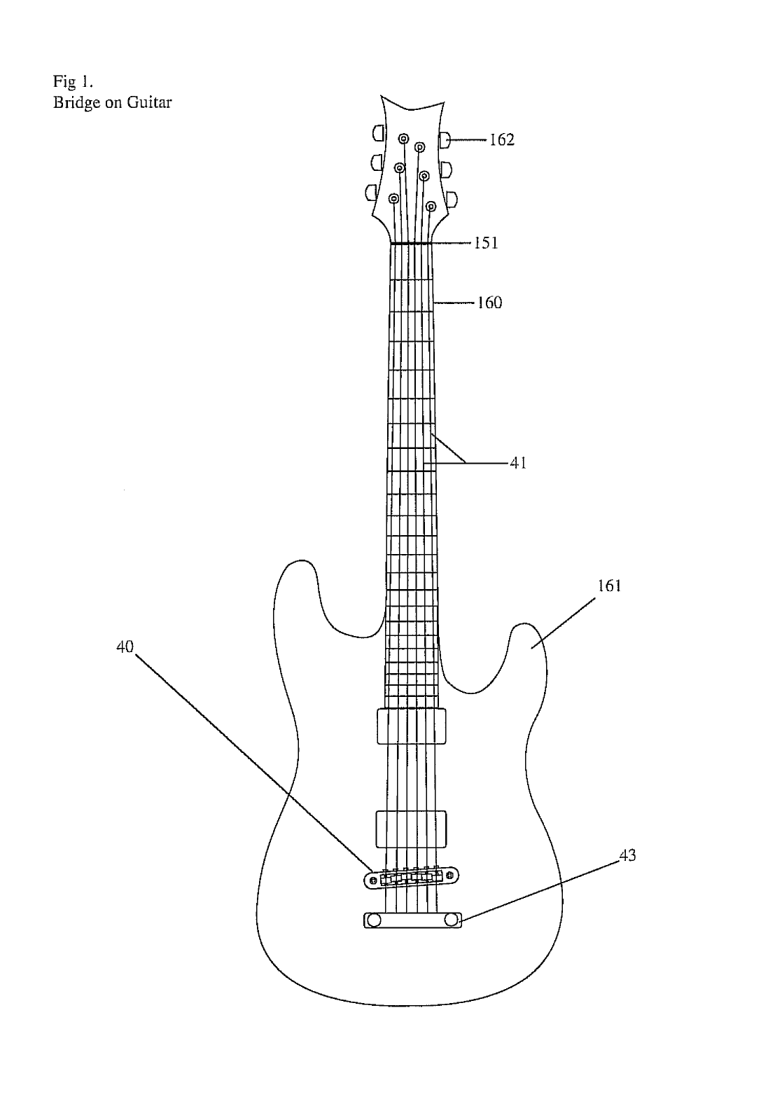

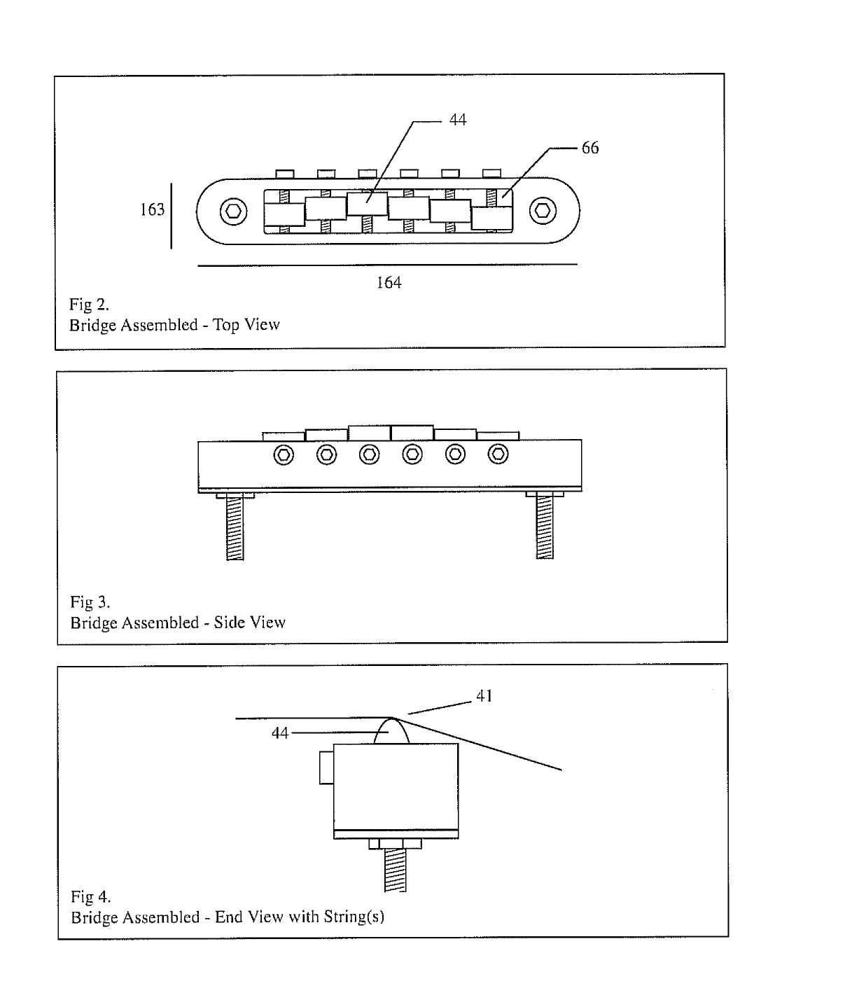

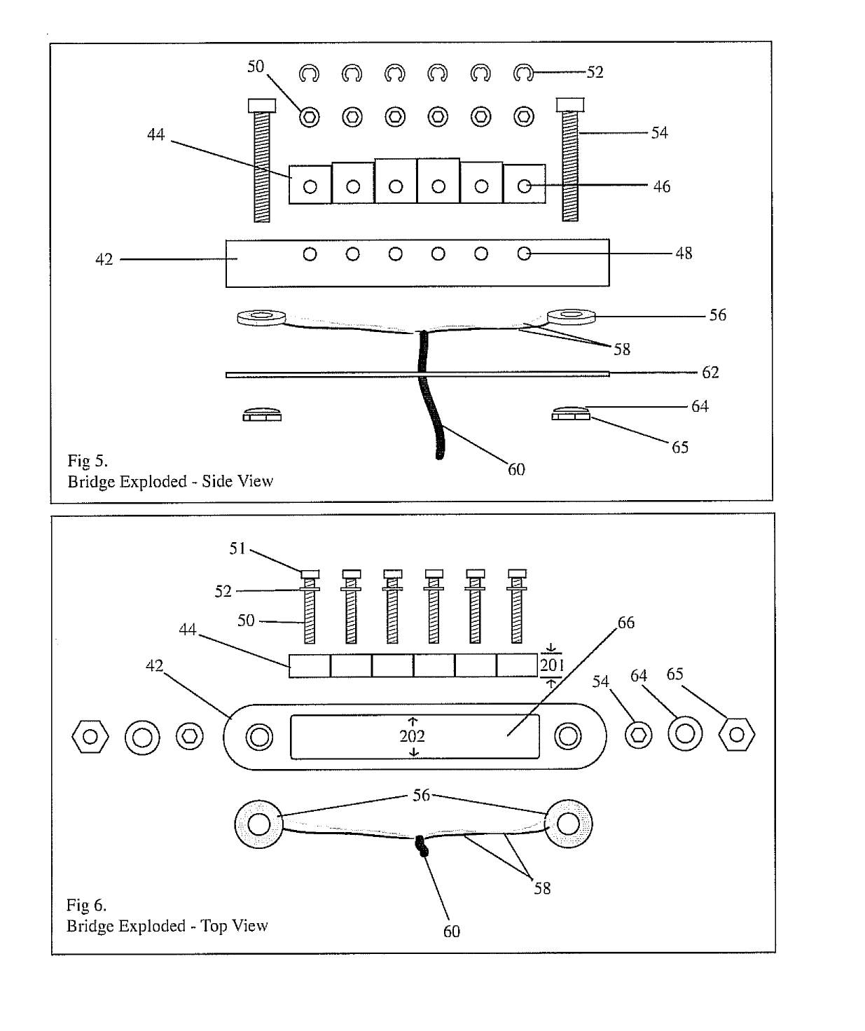

FIG. 1 shows a guitar that is composed of a neck 160, a body 161 and a plurality of strings 41. At the neck end of the guitar, the strings are supported in a conventional manner such as by a fingerboard nut 151 and secured by adjusting keys 162. At the body end of the guitar, the strings are supported by a bridge 40 and secured by a tailpiece 43. FIGS. 2 to 11 show different views of one embodiment of the instant bridge. The piezoelectric bridge comprises a first chamber 66 (FIGS. 2, 6 and 7), a second chamber 74 (FIG. 8), a transverse axis 163 and a longitudinal axis 164 (FIG. 2). A plurality of saddles 44 are positioned within the first chamber 66 (FIGS. 2, 5 and 6). The number of the saddles may be one, two, three, four, five, six, seven, eight or any other desired number. The number of the saddles may be the same as the number of the strings, with each string resting on one saddle. The number of the saddles may be different from the number of the strings. In the embodiments disclosed in FIGS. 2 to 11, the bridge has six saddles. The surface of the saddle 44 that is in contact with the string can be smooth, slotted, grooved, notched, or take any other desired structure so as to fit the string 41. Each saddle 44 has a threaded hole 46 oriented transversely across each saddle, wherein a threaded member 50 is positioned within the hole 46 (FIGS. 2, 5, 6 and 11). Each saddle 44 is threadably engaged with the threaded member 50. Each threaded member 50 has a head 51 at the front that can be rotated with a suitable tool (FIG. 6). The position of the saddle 44 within the first chamber 66 can be adjusted by rotating the threaded member 50 (FIGS. 2 and 11). Accordingly, the vibrating length of each string can be adjusted to fine tune the intonation of the instrument. A clip 52 clips around a notch cut in the threaded member 50 (FIGS. 5, 6 and 11). The clip 52 is in contact with the internal side wall of the first chamber 66 (FIG. 11) so that the linear movement of the threaded member 50 is restrained. In an alternative embodiment, the linear movement of the threaded member 50 is restrained by being engaged with a female threaded member that is in contact with the external side wall of the first chamber 66.

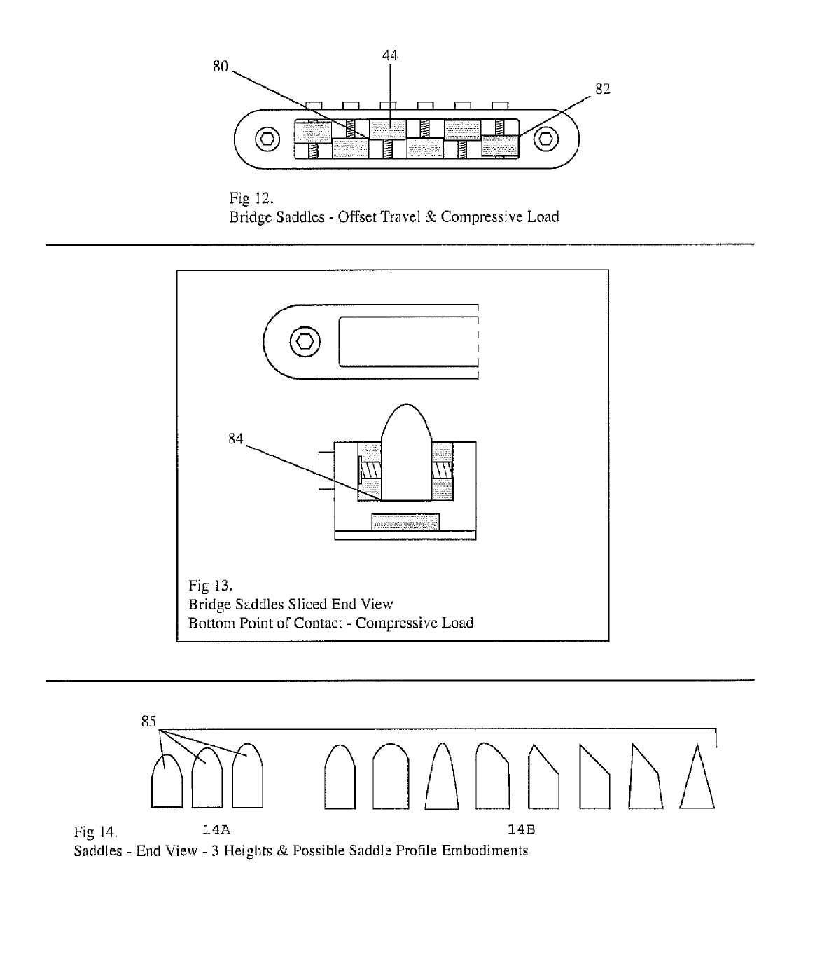

The bridge of the present invention may be made of comparatively light-weight, acoustically resonant material due to its structural design. The width 201 of the saddle 44 is greater than half the internal width 202 of the first chamber 66 (FIG. 6). Thus, adjacent saddles are always in direct contact 80 with each other (FIG. 12). The width of the saddle may be greater than, less than, or the same as, half the internal width of the first chamber. The saddles positioned at either end of the plurality of saddles are always in direct contact 82 with the end walls of the first chamber (FIG. 12). Each saddle is always in direct contact 84 with the internal bottom wall of the first chamber 66 (FIG. 13). The constant contacts between the saddles, and between the saddles and the end/bottom wall of the first chamber of the bridge, provide a compressive load that enables the instant bridge that is made of light-weight material to withstand even the heaviest load of strings. The downward pressure exerted by the strings on the bridge may range from about 4 kilogram (kg) to about 45 kg, from about 10 kg to about 40 kg, or from about 20 kg to about 30 kg.

The saddles located within the bridge of the present invention may be adjustable, or may be situated at fixed positions within the bridge. The saddles can be the same or different heights. In the embodiments shown in FIGS. 3, 5 and 14A, the six saddles positioned within a bridge are of three different heights to create an arc structure. Each saddle 44 may narrow at the top where the strings rest (FIG. 4). The thickness or width along the length of the saddle may be constant or taper from the end in contact with the internal bottom of the first chamber 66 to the end in contact with the string. Various embodiments of the saddle are shown in FIG. 14B.

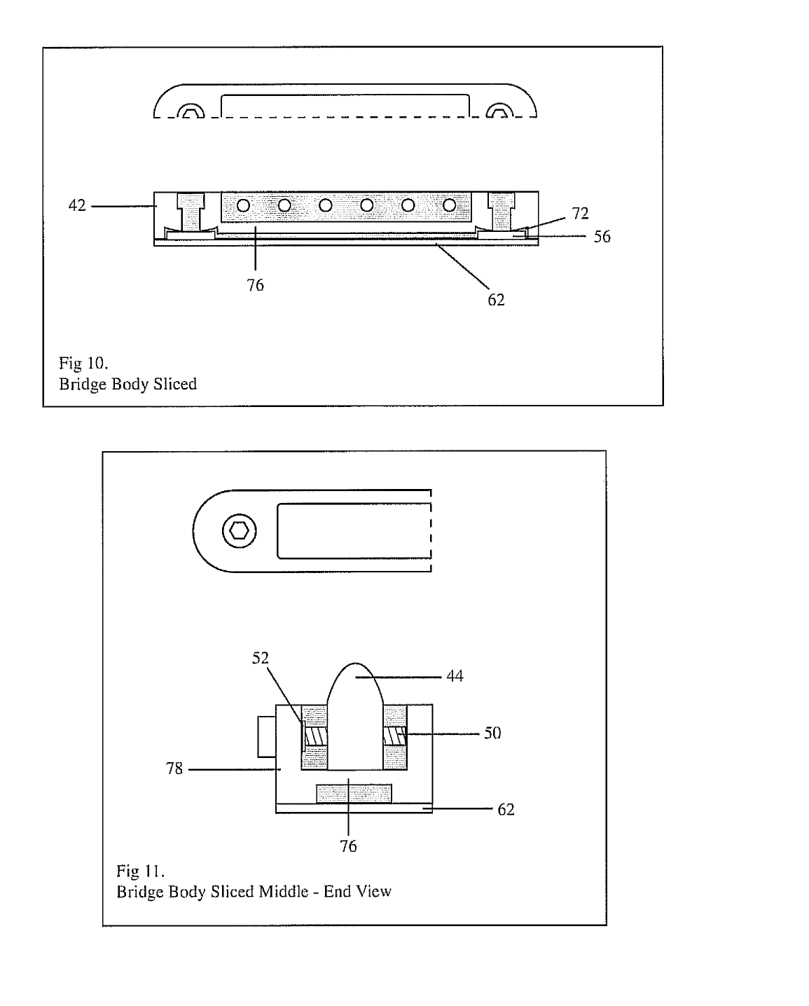

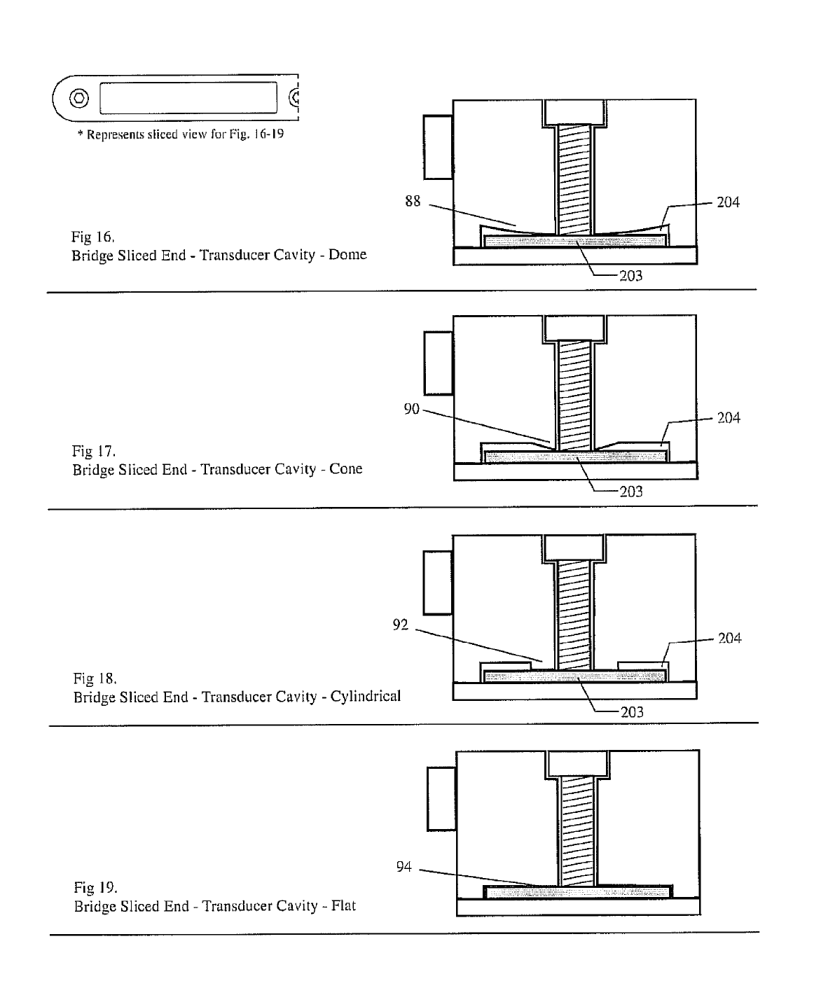

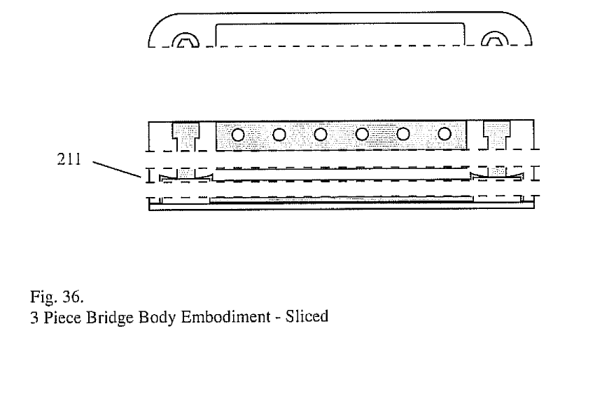

A second chamber 74 is positioned below the first chamber 66 and runs lengthwise across the longitudinal axis 164 of the bridge. The first chamber 66 and second chamber 74 share a wall 76 that acts as a primary diaphragm (FIG. 10). The primary diaphragm, the walls of the first chamber and the walls of the second chamber may be formed from a single piece of material (FIG. 10). The primary diaphragm may also be a separate structure that is further connected to the walls of the first chamber and the walls of the second chamber by adhesive, pin, or other suitable means (FIG. 36). The primary diaphragm can maximize the vibrations transmitted from the saddles to the piezoelectric elements. The plurality of saddles 44 positioned within the first chamber 66 are in direct contact with the primary diaphragm 76 (FIG. 11). At least one piezoelectric element is positioned within the second chamber 74. In one embodiment, there are two piezoelectric ring transducers 56 positioned within both ends 72 of the second chamber 74. As the bridge body is made of acoustically resonant material, the primary diaphragm 76 transmits string vibrations from the saddles 44 to the piezoelectric ring transducers 56. A portion of the second chamber 74 may be used for receiving the wires that are connected with the piezoelectric element. Either end 72 of the second chamber 74 may be the same or different shape in comparison to the mid-section of the second chamber. Either end 72 of the second chamber may be circular, oval, rectangular, or any other desired configuration so as to receive the piezoelectric element and facilitate the transmission of the string vibrations. The first and second chambers may be rectangular, square, or any other desired shape. The upper internal surface of the end 72 of the second chamber which contacts the piezoelectric element may have various configurations and shapes, the examples of which are shown in FIGS. 16-19. In some embodiments, a portion of the upper surface of the ends 72 of the second chamber is removed to create a hollow space 204, which allows free vibration of the upper side of the piezoelectric element (FIGS. 16-18). The upper surface of the chamber 72 may take the shape of a dome, cone, cylinder, or any other desired shape. The upper surface of the chamber 72 may be in direct contact with the piezoelectric element (FIG. 19). A peripheral diaphragm, which is a resonance structure, may be placed between the upper surface of the chamber 72 and the piezoelectric element 56. In one embodiment, only the center 203 of the piezoelectric element is supported, allowing its outer area to resonate freely to maximize signal strength. The width of the second chamber may range from about 0.5 mm to about 25 mm, from about 1 mm to about 20 mm, from about 1.5 mm to about 15 mm, or from about 2 mm to about 10 mm. The length of the second chamber may range from about 20 mm to about 180 mm, from about 30 mm to about 120 mm, or from about 40 mm to about 100 mm. The depth of the second chamber may range from about 0.5 mm to about 15 mm, from about 1 mm to about 10 mm, or from about 1.5 mm to about 6 mm. The upper surface of the second chamber 72 may have a diameter between about 5 mm and about 30 mm, between about 10 mm and about 25 mm, or between about 12 mm and about 20 mm.

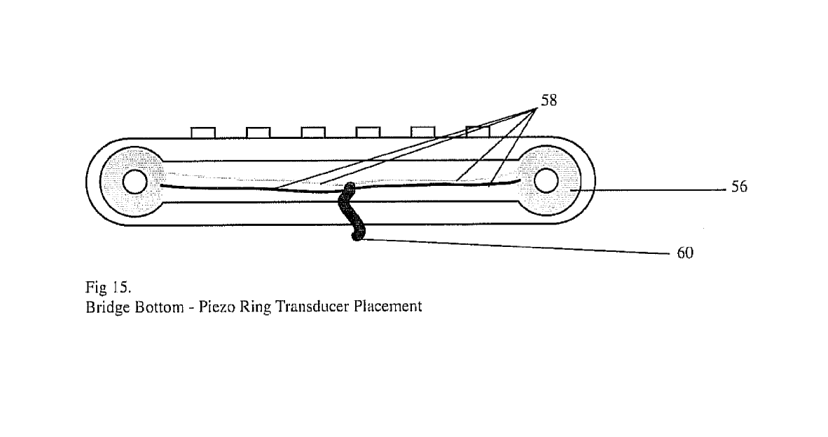

The piezoelectric element can be located in a position not in direct contact with the saddle, the examples of which is shown in FIG. 10. The piezoelectric element can also be in direct contact with the saddle. In one embodiment of the present invention, there is one piezoelectric element under each saddle. The piezoelectric elements may be the same or may be different. The distance between the piezoelectric elements may range from about 1 mm to about 200 mm, from about 20 mm to about 150 mm, from about 50 mm to about 100 mm, or about 60 mm. The piezoelectric elements may be wired together in series or in parallel. The piezoelectric elements may be wired in any suitable manner so as to achieve acoustic simulation. In one embodiment, piezoelectric elements are connected in parallel (i.e. positive to positive, negative to negative) by the insulated wire 58 (FIG. 15). The shield of the output wire 60 connects to the negative wire, while the center conductor of the output wire 60 connects to the positive wire. The output wire 60 protrudes through the bottom of the bridge and connects to an amplifier system. Authentic acoustic sounds may be achieved with this bridge without the use of any signal conditioning or pre-amplification.

The piezoelectric element of the present invention can comprise any desired piezoelectric material. In one embodiment, the piezoelectric material comprises at least a piezoelectric polymer, including, but not limited to, polyvinylidene fluoride (PVDF) copolymer and PVDF homopolymer. PVDF copolymers can include vinylidene/tetrafluorethylene and vinylidene/trifluoroethylene polymers. The piezoelectric material may comprise lead zirconatetitanate. The piezoelectric material may be manufactured by combining different polymeric elements and subjecting them to high temperatures which leads to a fused material containing a large number of crystals. U.S. Pat. Nos. 4,975,616 and 6,677,514. For other examples of piezoelectric materials, see, Piezoelectricity [on-line]. Retrieved on Oct. 28, 2009 from URL: <http://en.wikipedia.org/wiki/Piezoelectricity>

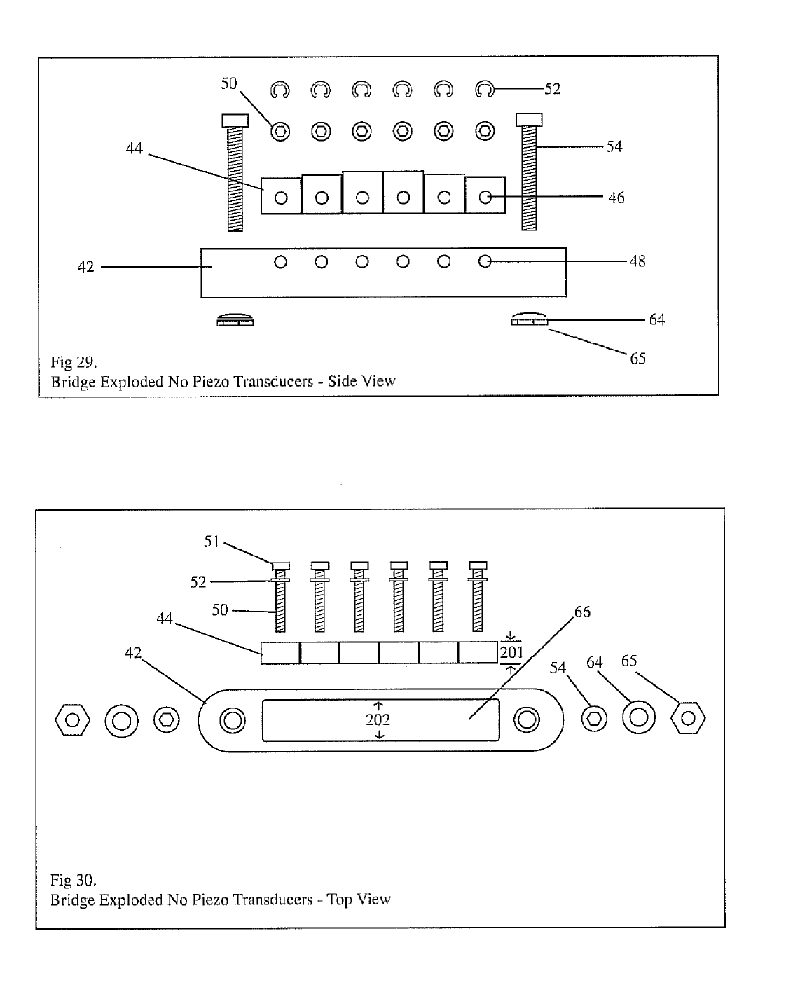

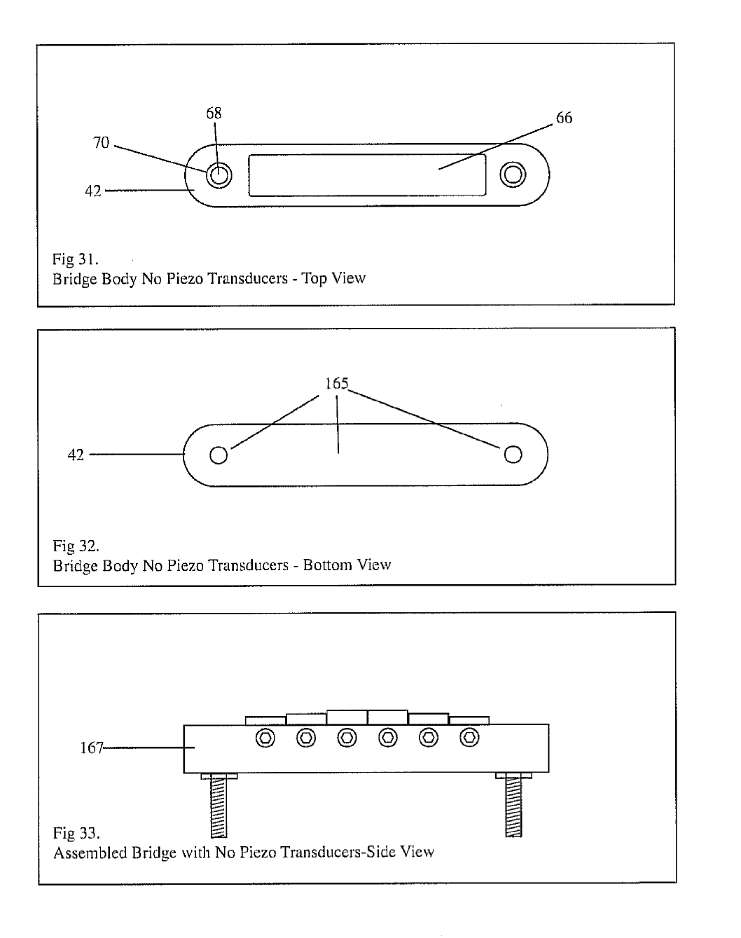

In some embodiments of the invention, the bridge comprises the saddles, the first chamber and the mounting members, etc., but does not comprise a second chamber or any piezoelectric element (FIGS. 29-33).

The second chamber 74 may be covered by a resonant structure 62 that acts as a secondary diaphragm in contact with the piezoelectric element 56 (FIG. 10). The secondary diaphragm 62 also acts as a bottom cover for the bridge and may be secured on its center to the bottom of the bridge body by adhesive or any other suitable means. Either end of the secondary diaphragm 62 may be in direct contact with the bottom surface of the piezoelectric element, and thus, may be left unsecured to the bridge body so that the secondary diaphragm 62 can vibrate against the piezoelectric elements. The thickness of the secondary diaphragm 62 may range from about 1 mm to about 5 mm, from about 1.5 mm to about 4 mm, or from about 2 mm to about 3 mm. The thickness of the secondary diaphragm may be constant across the whole structure, or may be different at various points of the structure. In one embodiment, the thickness of the secondary diaphragm 62 is less on the bass end of the bridge than on the treble end of the bridge.

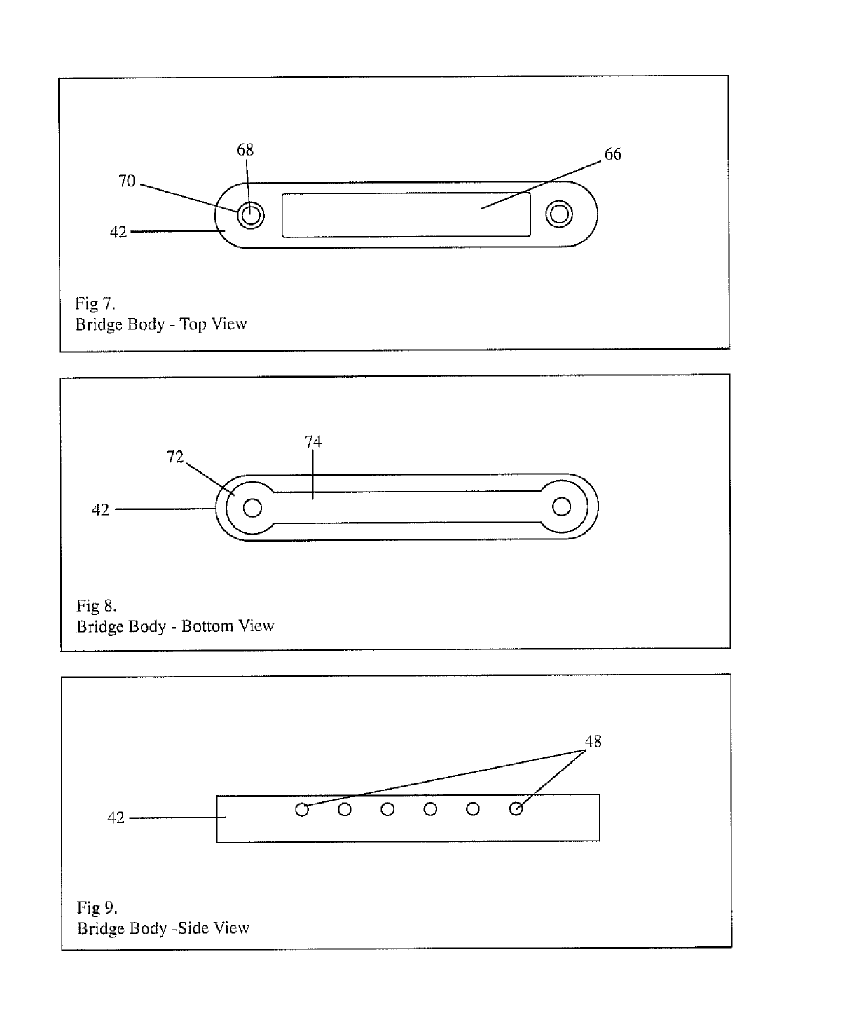

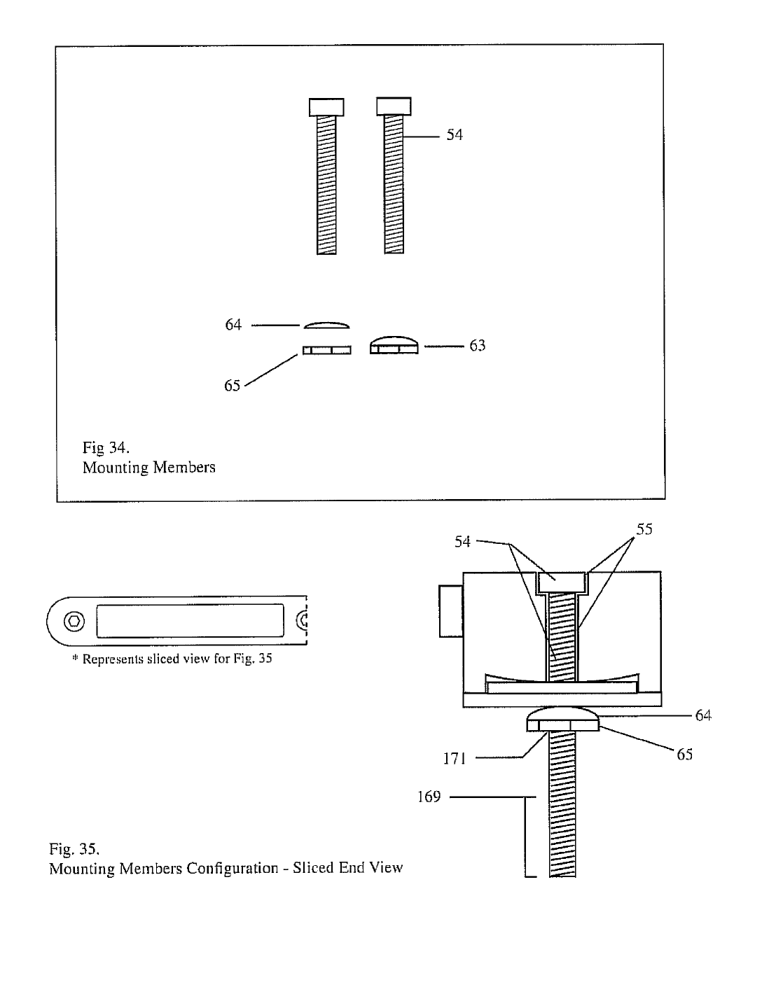

A portion of the bridge positioned at one end of the first chamber 66 has an unthreaded hole 68 oriented vertically with a mounting member 54 positioned within the hole 68 to mount the bridge to the instrument body (FIGS. 5 and 7). The mounting member 54 runs through, but is not in direct contact with, at least one piezoelectric element. The height of the bridge above the instrument body can be altered by adjusting the mounting member 54. In one embodiment, the mounting members are socket head allen bolts which are recessed flush with the top of the bridge and secured loosely under the bridge with a washer 64 and a nut 65 secured with adhesive to the allen bolt (FIG. 5). In one embodiment, the top surface of the washer is rounded (FIGS. 5 and 34). In another embodiment, the top surface of the nut is rounded (FIG. 34). Around the edge of the hole 68, there may be recessed surface 70 on the bridge body to receive the head of the allen bolt (FIG. 7). The bridge is raised and lowered via the allen bolts which thread into holes in the instrument or into threaded inserts installed in the body of the instrument. The mounting member is loosely fit 55 allowing for adjustment without binding (FIG. 35). The height adjustment system for bridges disclosed herein has been tested and proved to provide an easy and precise adjustment. In addition, the bridge does not detach when strings are changed on the instrument.

The constant contacts between adjacent saddles, between saddles and the end walls of the first chamber, and between saddles and the internal bottom wall of the first chamber collectively create a compressive load-bearing structure allowing for the bridge to be made of comparatively light-weight, acoustically resonant materials, and allowing for the bridge to comprise wall structures including the primary diaphragm and the secondary diaphragm. The compressive load-bearing structure can unify the plurality of parts in order to maximize the vibrations transmitted.

The bridge design of the present invention can be incorporated into any suitable existing bridge in the prior art. For example, the present bridge can be incorporated into the Fender style bridges, including, but not limited to, Fender Telecaster bridge, Fender base bridge, etc. See, Fender Telecaster [on-line]. Retrieved on Oct. 28, 2009 from URL: <http://en.wikipedia.org/wiki/Fender_Telecaster> and <http://en.wikipedia.org/wiki/Fender_Musical_Instruments_Corporation#Instruments>. The saddles of the Fender style bridge can be used in combination with the design of the present invention. The saddles may be made of metal, graphite, wood, fiberglass, carbon fiber, aluminum, bone, plastic, ivory, polyborontrinitrate, corian, micarta, phenolic, or combinations thereof. The present bridge comprises a transverse axis and a longitudinal axis. The bridge has at least one hole oriented vertically in the bridge with a mounting member positioned within the hole. The bridge is made of comparatively light-weight, acoustically resonant material. When the present bridge is used to modify bridges in the prior art, the present bridge may or may not have the first chamber, the second chamber or the piezoelectric element. In embodiments where the bridge comprises a first chamber, there is at least one saddle positioned within the first chamber. In embodiments where the bridge comprises a second chamber, there may be at least one piezoelectric element positioned within the second chamber. The height of the bridge may be adjusted by adjusting the mounting member. The mounting member may include a socket head allen bolt recessed into the top of the bridge and a nut. The incorporation of the present bridge into bridges of the prior art improves the acoustic simulation capability of the bridges of the prior art.

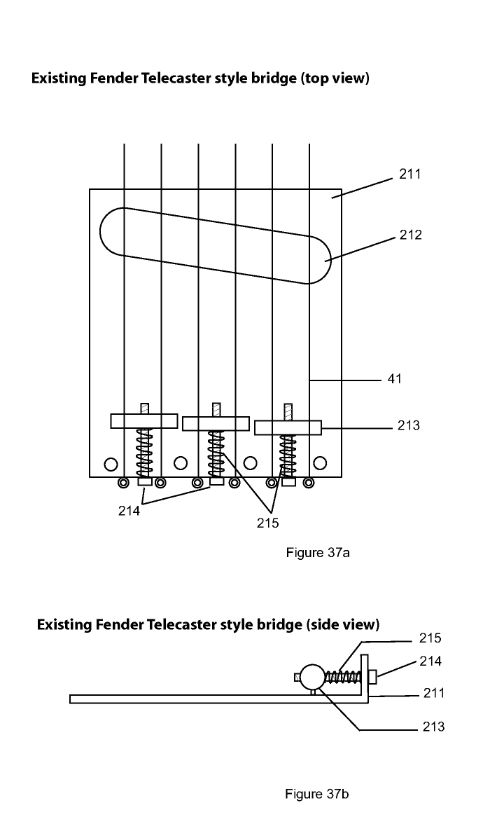

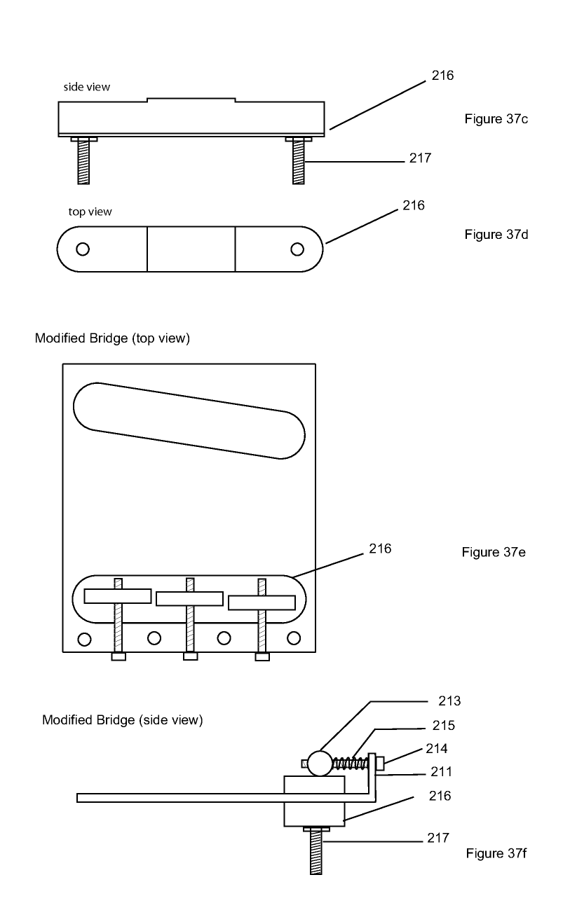

The bridge of the present invention can be incorporated into a Fender Telecaster style bridge. FIGS. 37a and 37b show a top view and a side view of the Fender Telecaster style bridge, respectively. The Fender Telecaster style bridge has a metal bridge base plate 211, and a cavity in base plate for magnetic pickup 212. String 41 rests on saddle 213. The position of each of the saddles may be adjusted by saddle screw 214 and saddle spring 215. FIGS. 37c and 37d show a side view and a top view, respectively, of the present bridge 216 that can be incorporated into the Fender Telecaster style bridge. The bridge 216 may or may not have the first chamber, the second chamber or the piezoelectric element. The height of the bridge can be adjusted by adjusting the mounting member 217. The bridge 216 is made of any suitable comparatively light-weight, acoustically resonant material including, but not limited to, wood, fiberglass, carbon fiber, graphite, aluminum, bone, plastic, ivory, polyborontrinitrate, corian, micarta, phenolic, and their combinations. FIGS. 37e and 37f show a top view and a side view, respectively, of bridge 216 that is incorporated into the Fender Telecaster style bridge. Bridge 216 may be mounted on the guitar body by two mounting members 217 which go through holes in the metal base plate. Bridge 216 may fit into a recessed cavity in the guitar body.

The piezoelectric bridge of the present invention has been tested and proved to be able to produce sounds like those of a flat top acoustic guitar, an arch-top jazz guitar, and a number of natural sounds similar to those produced by an acoustic guitar. The present piezoelectric bridge allows an electric guitar to deliver authentic acoustic tone without any pre-amplification or signal conditioning.

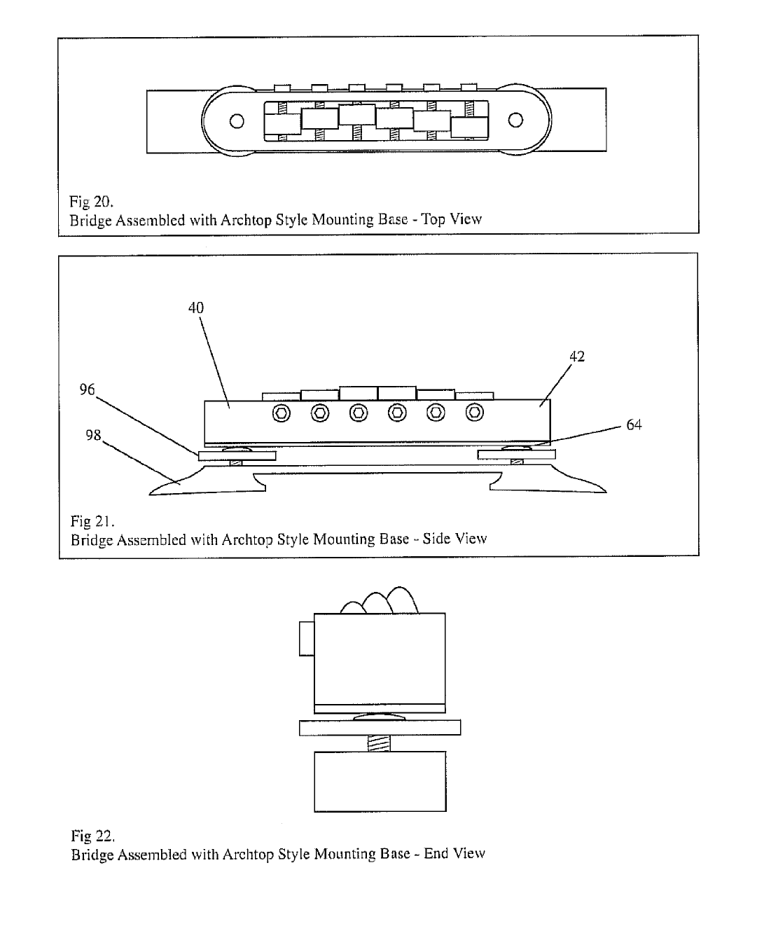

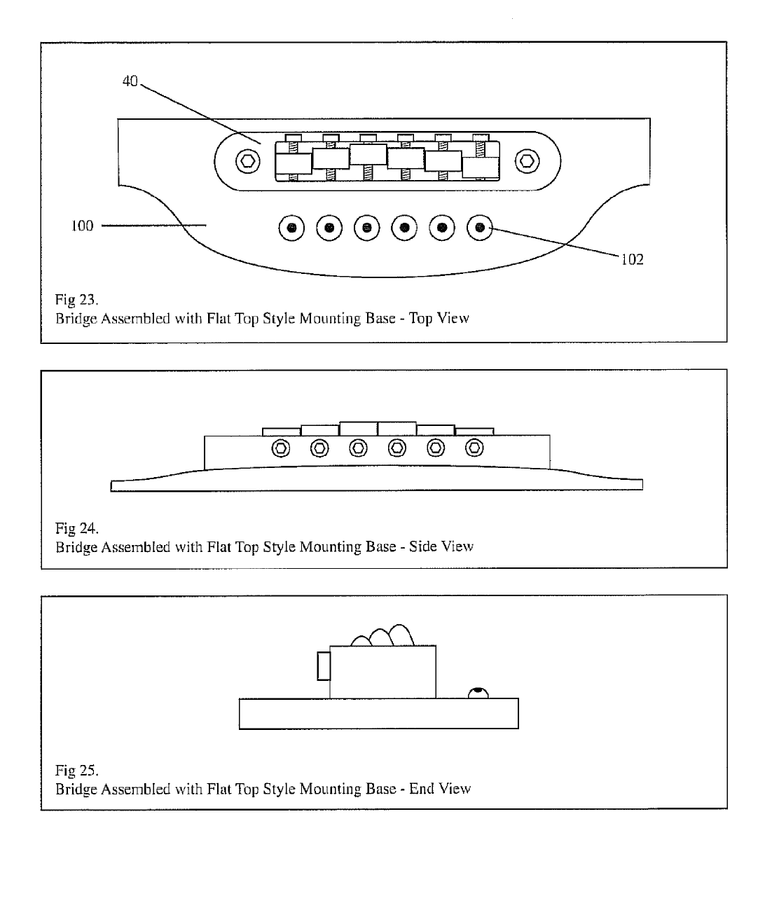

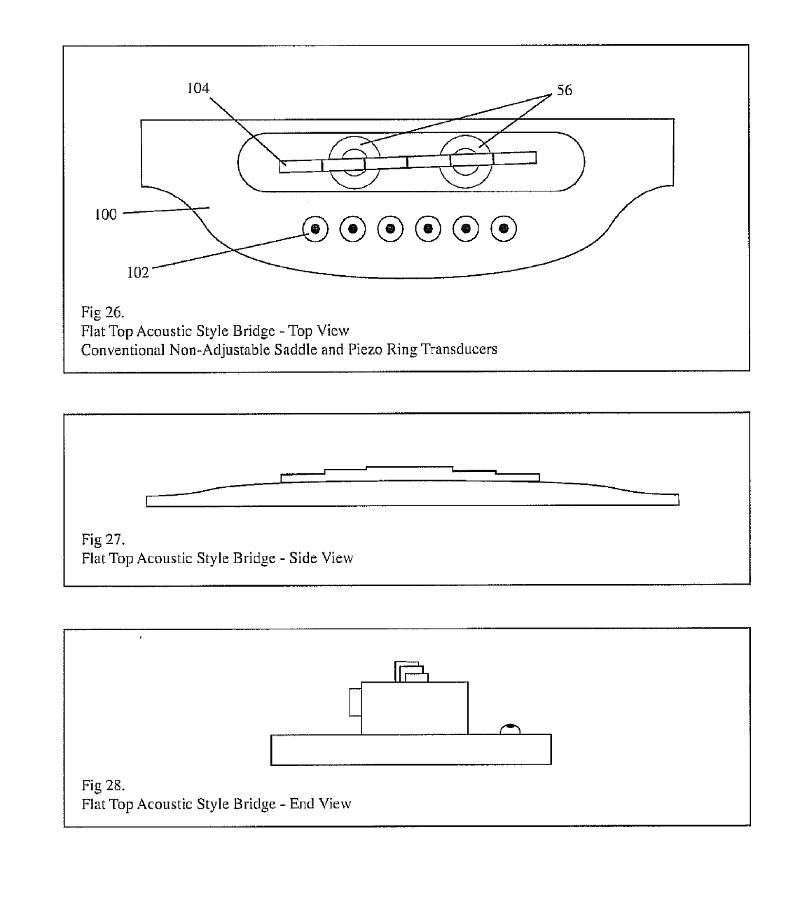

The bridge of the present invention may be used on a guitar, including an electric guitar or an acoustic guitar. The saddles positioned within the bridge may be adjustable or non-adjustable (FIGS. 20-27). The bridge may be mounted on an instrument without a mounting base, or with a mounting base, including an arch-top style mounting base (FIGS. 20-22), a flat top style mounting base (FIGS. 23-25), or any other desired mounting bases. The bridge of the present invention may also be used on any other stringed instrument, including, but not limited to, bass guitar, mandolin, ukulele, steel guitar, dulcimer, autoharp, violin, cello, viola, double bass, oud, sitar, banjo, rebab, rebec, hardingfele, nyckelharpa, kokyu, erhu, igil, kamanche, sarangi, hurdy gurdy, chapman stick, megatar, koto (see, List of String Instruments [on-line]. Retrieved on Oct. 20, 2008 from URL: http://en.wikipedia.org/wiki/List_of_string_instruments).

The scope of the present invention is not limited by what has been specifically shown and described hereinabove. Those skilled in the art will recognize that there are suitable alternatives to the depicted examples of materials, configurations, constructions and dimensions. Numerous references, including patents and various publications, are cited and discussed in the description of this invention. The citation and discussion of such references is provided merely to clarify the description of the present invention and is not an admission that any reference is prior art to the invention described herein. All references cited and discussed in this specification are incorporated herein by reference in their entirety. Variations, modifications and other implementations of what is described herein will occur to those of ordinary skill in the art without departing from the spirit and scope of the invention. While certain embodiments of the present invention have been shown and described, it will be obvious to those skilled in the art that changes and modifications may be made without departing from the spirit and scope of the invention. The matter set forth in the foregoing description and accompanying drawings is offered by way of illustration only and not as a limitation.

What is claimed is:

1. A bridge for a musical instrument comprising a first chamber, a transverse axis and a longitudinal axis,
wherein a plurality of saddles are positioned within the first chamber, adjacent saddles in direct contact at any position, at least one side of each saddle in contact with at least one wall of the first chamber, the saddles that are positioned at either end of the plurality of saddles in direct contact with the end walls of the first chamber,
each saddle having a hole oriented transversely across the saddle, wherein a threaded member is positioned within the hole, the threaded member being attached to one side of the first chamber,
a mounting means at both ends of the bridge for attaching the bridge to the musical instrument.

2. The bridge of claim 1, wherein the position of the saddle can be adjusted by adjusting the threaded member.

3. The bridge of claim 1, wherein the width of the saddle is greater than half of the internal width of the first chamber.

4. The bridge of claim 1, wherein the bridge is made of light-weight acoustically resonant material.

5. The bridge of claim 1, wherein the saddles are made of light-weight acoustically resonant material.

6. The bridge of claim 4 or 5, wherein the light-weight acoustically resonant material is selected from the group consisting of wood, aluminum, fiberglass, carbon fiber, graphite, bone, plastic, ivory, polyborontrinitrate, corian, micarta, phenolic, and combinations thereof.

7. The bridge of claim 1, wherein the bridge further comprises a second chamber positioned below the first chamber and runs lengthwise across the longitudinal axis of the bridge.

8. The bridge of claim 7, wherein at least one piezoelectric element is positioned within the second chamber.

9. The bridge of claim 1, wherein the mounting means is a mounting member positioned within a hole oriented vertically in the bridge.

10. The bridge of claim 9, wherein the mounting member runs through, but is not in direct contact with, the piezoelectric element.

11. The bridge of claim 8, wherein at least one of the piezoelectric elements is a piezoelectric ring transducer.

12. The bridge of claim 11, wherein at least one of the piezoelectric ring transducer encircles at least one of the mounting means on at least one end of the bridge.

13. The bridge of claim 11, wherein the diameter of the piezoelectric ring transducer is from about 10 mm to about 30 mm.

14. The bridge of claim 13, wherein the diameter of the piezoelectric ring transducer is from about 12 mm to about 25 mm.

15. The bridge of claim 14, wherein the diameter of the piezoelectric ring transducer is from about 15 mm to about 20 mm.

16. The bridge of claim 8, wherein the thickness of the piezoelectric element is from about 1 mm to about 6 mm.

17. The bridge of claim 16, wherein the thickness of the piezoelectric element is from about 2 mm to about 5 mm.

18. The bridge of claim 17, wherein the thickness of the piezoelectric element is about 3 mm.

19. The bridge of claim 8, wherein at least a portion of the upper surface of the second chamber is recessed to allow greater vibration of the piezoelectric element.

20. The bridge of claim 19, wherein a peripheral diaphragm is placed between the recessed surface of the second chamber and the piezoelectric element.

21. The bridge of claim 7, wherein a primary diaphragm separates the first chamber and the second chamber.

22. The bridge of claim 21, wherein the thickness of the primary diaphragm is from about 1 mm to about 10 mm.

23. The bridge of claim 22, wherein the thickness of the primary diaphragm is from about 2 mm to about 8 mm.

24. The bridge of claim 23, wherein the thickness of the primary diaphragm is from about 3 mm to about 6 mm.

25. The bridge of claim 8, wherein a secondary diaphragm is placed in contact with the side of the piezoelectric element that is further from the first chamber.

26. The bridge of claim 25, wherein the thickness of the secondary diaphragm is from about 1 mm to about 5 mm.

27. The bridge of claim 26, wherein the thickness of the secondary diaphragm is from about 1.5 mm to about 4 mm.

28. The bridge of claim 27, wherein the thickness of the secondary diaphragm is from about 2 mm to about 3 mm.

29. The bridge of claim 8, wherein the surface area where the second chamber is in contact with the piezoelectric element is less than the area of the piezoelectric element.

30. The bridge of claim 1, wherein the mounting means can be used to adjust the height of the bridge.

31. The bridge of claim 1, wherein the constant contacts between adjacent saddles, between saddles and the end walls of the first chamber, and between saddles and the internal bottom wall of the first chamber collectively create a compressive load-bearing structure allowing for the bridge to be made of light-weight acoustically resonant materials.

32. The bridge of claim 1, 21 or 25, wherein the constant contacts between adjacent saddles, between saddles and the end walls of the first chamber, and between saddles and the internal bottom wall of first chamber collectively create a compressive load-bearing structure allowing for the bridge to comprise wall structures including the primary diaphragm and the secondary diaphragm.

33. The bridge of claim 1, wherein the constant contacts between adjacent saddles, between saddles and the end walls of the first chamber, and between saddles and the internal bottom wall of first chamber collectively create a compressive load-bearing structure which unifies the plurality of parts in order to maximize the vibrations transmitted.

34. A bridge for a musical instrument comprising a transverse axis and a longitudinal axis, the bridge having at least one hole oriented vertically in the bridge with a mounting member positioned within the hole, wherein the bridge is made of light-weight acoustically resonant material.

35. The bridge of claim 34, wherein the light-weight acoustically resonant material is selected from the group consisting of wood, aluminum, fiberglass, carbon fiber, graphite, bone, plastic, ivory, polyborontrinitrate, corian, micarta, phenolic, and combinations thereof.

36. The bridge of claim 34, wherein the bridge further comprises a first chamber wherein at least one saddle is positioned within the first chamber.

37. The bridge of claim 34, wherein the bridge further comprises a second chamber wherein at least one piezoelectric element is positioned within the second chamber.

38. The bridge of claim 34, wherein the mounting member can be used to adjust the height of the bridge.
